(19) United States
(12) Patent Application Publication
(10) Pub. No.: US 2008/0113075 A1
(43) Pub. Date: May 15, 2008

(54) Compositions

(75) Inventors: Marijke De Brouwer, Lebbeke-Wieze (BE); Veerle Derycke, Lebbeke-Wieze (BE)

Correspondence Address: HOXIE & ASSOCIATES LLC, 75 MAIN STREET , SUITE 301, MILLBURN, NJ, 07041, US

(73) Assignee: Barry Callebaut AG, Zurich (CH)

(21) Appl. No.: 11/924,687

(22) Filed: Oct. 26, 2007

Related U.S. Application Data
(60) Provisional application No. 60/857,817, filed on Nov. 9, 2006.

(51) Int. Cl. A23G 3/42; A23G 1/46; A23G 1/40

(52) U.S. Cl. 426/584; 426/660; 426/631

(57) ABSTRACT

A fat continuous confectionery composition comprises less than 2% by weight of a fermentable sugar, and a sweetening component in an amount of at least 25% by weight of the composition. The sweetening component comprises at least 50% by weight non-hydrogenated isomaltulose and may also comprise at least 5% by weight inulin, dextrin or a mixture of inulin and dextrin. The composition may comprise milk or whey protein in an amount of between 1 and 10% by weight of the composition.

This application claims benefit, under 35 U.S.C. § 119(e), of U.S. Provisional Application No. 60/857,817, filed on Nov. 9, 2006, which is incorporated herein by reference in its entirety.

This invention relates to confectionery compositions, in particular chocolate compositions having reduced adverse dental effect, for example caries.

There are many chocolate and chocolate-like products. Chocolate-like products are materials in which at least a part of the cocoa butter in chocolate is replaced by another fat, such as butterfat, or a vegetable fat such as a cocoa butter equivalent (CBE) or other vegetable fats. Processes for producing chocolate and chocolate-like products typically involve dispersing finely ground ingredients in a fat phase. The finely ground ingredients may include, for example, cocoa solids, sugar and optionally milk solids. The ingredients that are used are dictated by the nature of the product. Plain chocolate contains cocoa solids but generally does not contain non-fat milk solids, whereas milk chocolate does contain non-fat milk solids and milk fat as additional ingredients. White chocolate is prepared without the addition of cocoa mass or cocoa powder. The fat used to produce the chocolate is typically cocoa butter, optionally at least partly replaced by another fat in chocolate-like products.

It is known that some sugars, e.g. saccharose, can expedite tooth decay and dental caries, in particular in combination with human saliva. Thus, after consumption of confectionery, pH levels measured around dental plaques decline typically to below 6, for example 5.7 to 4.5, thereby reflecting a strongly acidic environment. Many attempts have been made to formulate confectionery in order to reduce and minimise adverse effects on teeth and generally support dental health.

Such compositions may include a polyol component, for example maltitol. Despite the merits of such compositions, drawbacks encountered include undesirable laxative effects, inconvenient bulk-scale handling, poor taste and unacceptable mouth feel.

The present applicants have sought to overcome the disadvantages of hitherto known reduced-sugar polyol-based confectionery compositions.

WO 93/02566 relates to reduced calorie confectionery compositions in which the sugar is replaced by products such as inulin.

EP-A-0674840 describes a process for producing a sucrose-free water-containing milk chocolate. The chocolate product has a shell encapsulating a water-in-oil emulsion.

WO 98/04156 discloses a sugar substitute composition for table top, baking and cooking applications.

WO 2006/015880 relates to a functional sugar replacement comprising a polysaccharide and a high intensity sweetener.

U.S. Pat. No. 4,980,189 describes a process for the manufacture of sucrose-free, dietetic and/or teeth-sparing chocolate. The chocolate is prepared from a sugar-free crumb.

EP-A-0933029 and U.S. Pat. No. 6,592,927 disclose a method of preparing chocolate having a reduced content of fermentable sugars. The method relies on the formation of a skimmed milk powder substitute.

EP-A-0285187 relates to reduced calorie and reduced fat confectionery compositions in which a nondigestible fatty polyester or polyether is substituted for natural fat and an artificial sweetener plus a partially or wholly nondigestible carbohydrate bulking agent is substituted for sugar.

There remains a need for confectionery compositions which can minimise adverse effects on teeth and generally support dental health and still have good taste and mouth feel.

In one aspect, therefore, this invention provides a fat continuous confectionery composition which comprises less than 2% by weight of a fermentable sugar or mixture of fermentable sugars, and a sweetening component in an amount of at least 25% by weight of the composition, wherein the sweetening component comprises at least 50% by weight non-hydrogenated isomaltulose and at least 5% by weight inulin, dextrin or a mixture of inulin and dextrin.

In another aspect, the invention provides a fat continuous confectionery composition which comprises: milk or whey protein in an amount of between 1 and 10% by weight of the composition; less than 2% by weight of a fermentable sugar; and a sweetening component in an amount of at least 25% by weight of the composition, wherein the sweetening component comprises at least 50% by weight non-hydrogenated isomaltulose.

The applicants understand the term “fat continuous confectionery composition” to mean a substantially homogeneous composition, optionally containing dispersed particles. Examples include chocolate and conventional confectionery fillings such as chocolate and non-chocolate fillings. Preferably, chocolate is distinguished from chocolate fillings in being predominantly solid at 25° C.

The compositions of this invention may be free of or substantially free of polyols, for example erythritol, galactitol, isomalt, lactitol, maltitol, mannitol, polydextrose, sorbitol, tagatose, trehalose, xylitol and hydrogenated starch hydrolysates. It will be understood that the term “polyols” in this context does not include the isomaltulose, dextrin and inulin that may be present in the compositions of the invention.

Typically, fermentable sugars are present in an amount of less than 1% by weight of the composition, for example less than 0.8%, less than 0.6%, less than 0.5%, less than 0.4%, less than 0.3% or less than 0.2%. Fermentable sugars include fructose, glucose, lactose and sucrose, and mixtures thereof.

Compositions of the present invention may contain at least one type of milk protein or at least one type of whey protein. Suitable amounts of milk or whey proteins are between 1 and 10% by weight of the composition. A suitable milk protein product is available commercially under the trademark Promilk 872 B from the Ingredia company. Preferably, the milk protein or whey protein is incorporated into the composition as a product that comprises at least 75% by weight protein, more preferably at least 80% by weight protein such as at least 85% by weight protein, for example at least 90% by weight protein. Examples of these preferred products are whey protein isolates. For example, the compositions of the invention preferably comprise from 1 to 10% by weight of a whey protein isolate that comprises at least 75% by weight protein, more preferably at least 80% by weight protein such as at least 85% by weight protein, for example at least 90% by weight protein.

The sweetening component may contain at least 60% isomaltulose, more preferably at least 70% isomaltulose, for example at least 75%, or higher e.g. at least 80%, at least 85% or at least 90% by weight. The isomaltulose is non-hydrogenated. The isomaltulose is available commercially, for example under the tradename Palatinose from the Südzucker company or Isomaltidex from the Cerestar company.

The sweetening component may comprise dietary fibre, for example inulin, dextrin or a combination of inulin and dextrin. The sweetening component may be present, for example, in an amount of at least 30%, at least 40%, at least 45%, at least 50%, at least 55%, at least 60% or at least 65% by weight or higher, in the confectionery composition of this invention.

When present without dextrin, inulin is present in an amount of 5 to 50% by weight, for example 10, 15, 20, 25, 30, 35, 40 or 45%, of the sweetening component. If no dextrin is present, the inulin comprises at least 5% by weight of the sweetening component.

When present without inulin, dextrin is present in an amount of 5 to 50% by weight, for example 10, 15, 20, 25, 30, 35, 40 or 45%, of the sweetening component. If no inulin is present, the dextrin comprises at least 5% by weight of the sweetening component.

If a dextrin/inulin mixture is used in the sweetening component, the mixture is present in an amount of 5 to 50% by weight, for example 10, 15, 20, 25, 30, 35, 40 or 45%, of the sweetening component. The weight ratio of dextrin to inulin may be between 1:20 to 20:1, for example 1:15, 1:10, 1:5, 1:1, 5:1, 10:1 or 15:1, such as from 15:1 to 1:15, for example from 10:1 to 1:10, e.g., from 5:1 to 1:5.

The inulin component may comprise 10 to 90% by weight, e.g. 20 to 80%, short-chain fibres (preferably having a DP of less than 10, more preferably an average DP of less than 6) and 90 to 10% by weight, e.g. 80 to 20%, long-chain fibres (preferably having a DP of up to about 80, such as an average DP of from 7 to 60).

Suitable inulin fibres are available commercially under the tradenames Beneo HP and Raftiline HP from the Orafti company.

A suitable dextrin is commercially available under the tradename Nutriose FM10 from the Roquette company.

In a preferred aspect, the sweetening component consists of or consists essentially of isomaltulose in an amount of at least 50% by weight, for example, at least 60%, at least 70%, at least 75% or higher e.g. at least 80%, 85% or 90%; and at least 5% by weight inulin or dextrin or a mixture of inulin and dextrin.

The sweetening component contains up to 95% by weight non-hydrogenated isomaltulose.

Preferred confectionery compositions of the invention include chocolate and chocolate-like products. These compositions will comprise typical components of chocolate or chocolate-like products. Preferred components include cocoa solids, fats, emulsifiers, flavouring agents and mixtures thereof. Preferably, the cocoa solids are selected from cocoa powders, expeller flake and mixtures thereof.

Fats are preferably selected from the group consisting of cocoa butter, cocoa butter equivalents, butter fat or fractions thereof, palm oil or fractions thereof, coconut or fractions thereof, palm kernel oil or fractions thereof, liquid oils (for example, sunflower oil and/or rapeseed oil), interesterified mixtures of the above fats or fractions or hardened components thereof, or mixtures of one or more of the fats or oils mentioned.

Cocoa liquor or cocoa mass may be used to incorporate at least part of the cocoa butter and cocoa solids together.

Emulsiflers that are preferably used are selected from the group consisting of lecithin, fractionated lecithin and PGPR or mixtures thereof. Flavouring agents that may be added are preferably selected from the group consisting of vanilla and caramel or mixtures thereof.

In one embodiment, the compositions of this invention comprise constituents typically used in chocolate. Thus, the following constituents may be present in weight % based on the total weight of the composition:

Cocoa butter: between 15 and 30% by weight.

Cocoa liquor: between 5 and 60% by weight, e.g. 10 to 45% by weight.

Emulsifier: the applicants have found that suitable emulsifiers include lecithin, fractionated lecithin, ammonium phosphatide (AMF), castor oil lipids or polyglycerol polyricinoleate (PGPR), or a mixture of two or more of these. The emulsifier may be present in an amount of up to about 1%, e.g. 0.5 to 0.7% by weight based on the total weight of the composition.

Vanillin: 0.01 to 0.1%, e.g. 0.02 to 0.05% by weight.

A preferred milk chocolate according to the invention comprises:
from 15 to 30% by weight cocoa butter;
from 10 to 25% by weight cocoa mass or cocoa liquor;
from 3 to 10% by weight milk protein or whey protein;
from 30 to 60% by weight isomaltulose; and
optionally, up to 15% by weight inulin.

A preferred dark chocolate according to the invention comprises:
from 10 to 25% by weight cocoa butter;
from 25 to 50% by weight cocoa mass or cocoa liquor;
from 30 to 60% by weight isomaltulose; and
from 5 to 15% by weight inulin.

The percentages of the components, together with any other components present, will add up to 100%.

The water content of compositions of this invention may be below 1.75% by weight, for example 1.5% or lower, e.g. 1% by weight based on the total weight of the composition.

The compositions of the present invention are free of intensive sweeteners such as acesulfame potassium (Acesulfame K, ace K), aspartame (aspartic acid+phenylalanine), neotame, saccharine, sucralose and thaumatine.

The compositions of this invention may be prepared using conventional ingredient mixing and processing methods.

Chocolate and chocolate-like products are typically formed into a desired shape. The chocolate or chocolate-like product may comprise one or more food additives, such as biscuit, nuts (whole or pieces), crispies, sponge, wafer or fruit, such as cherries, ginger and raisins or other dried fruit. These additives are normally embedded in the chocolate or chocolate-like product in the final product.

The chocolate or chocolate-like products may take any suitable form and may, for example, be packaged and sold as a block or a bar. Alternatively or additionally, the chocolate or chocolate-like product of the invention may optionally be filled and may be used as a coating. For example, the chocolate or chocolate-like product may be used in other confectionery and bakery applications, for example as a cake coating or filling, a biscuit coating or filling, a sponge coating or filling or a coating layer for an ice cream.

The chocolate or chocolate-like products may optionally have further additives added prior to the final use of the product. For example, the fat content may be increased to from 35% to 50% (such as about 45%) by weight by adding fat to the chocolate or chocolate-like product prior to use as an ice cream coating.

The chocolate or chocolate-like products may be used in applications comprising, for example, one or more of moulding, enrobing, dipping, bottoming, filling and panning.

Confectionery fillings preferably comprise flavouring agents. Suitable flavouring agents include, but are not limited to, fruit, nut, and vanilla flavourings, fruit powder and pieces, nuts, vanilla, herbs (e.g., mint), herb flavourings, caramel and caramel flavourings. Those skilled in the art are familiar with numerous flavourings than can be used.

Measurements of pH in interdental plaque are taken using telemetry, each subject having a telemetric prosthesis incorporating a miniature glass pH electrode. This methodology is described in e.g. Caries Res. 21, 555-558, 1987 (Firestone et al.), and Pediatric Dentistry 2, 87, 1980 (Imfeld et al.), which is incorporated by is reference.

Sucrose rinses or standard chocolate with sugar are used as positive control. The measurements are carried out with 3 to 7 day-old interdental plaque covering the electrodes, i.e. the subjects take no oral hygiene measures absent water rinses.

This result from these measurements is defined as the Interdental Plaque pH (IPP).

Preferably, the measurements are conducted within about one hour, for example, less than one hour, less than 30 minutes, and less than 15 minutes following consumption.

The present invention provides improved confectionery, in particular chocolate, compositions with a substantially reduced sugar content or saccharose-free which are dentally better tolerated than hitherto known “tooth-friendly” compositions.

The compositions of the invention demonstrate several advantages over known compositions. Thus, the compositions of this invention:
are more easily processed on an industrial scale;
provide an acceptable taste profile;
present an improved mouth-feel;
are suitable for consumption by adults and children;
avoid a laxative effect.

The listing or discussion of an apparently prior-published document in this specification should not necessarily be taken as an acknowledgement that the document is part of the state of the art or is common general knowledge. Throughout this specification, all percentages, parts and ratios are by weight unless indicated otherwise.

Following is a description by way of example only of chocolate compositions of this invention.

### EXAMPLES

### Dental Effect

Two 40 kg batches are prepared, using the recipes of Examples 1 and 2.

### Example 1

Milk chocolate

| | % weight |
|---|---|
| Cocoa butter | 22.5 |
| Cocoa liquor | 15.5 |
| Milk proteins (Promilk 872B) | 7.5 |
| Isomaltulose | 40.0 |
| Inulin (Beneo HP) | 8.5 |
| Butter oil | 5.5 |
| Lecithin | <1 |
| Vanillin | <1 |
| | 100 |

A 40 kg batch is prepared using the above composition recipe. After processing and conching, tablet bars are produced.

A first panel of six healthy adult subjects each consume a bar. The IPP is measured during and 30 minutes post-consumption and is greater than 6 and less than 7. There is no IPP below 6.0 during or at 30 minutes following consumption of the chocolate.

### Example 2

Dark chocolate

| | % weight |
|---|---|
| Cocoa butter | 16.5 |
| Cocoa liquor | 32.5 |
| Isomaltulose | 40.5 |
| Inulin | 10.0 |
| Ammonium phosphatides | <1 |
| Vanillin | <1 |
| PGPR | <1 |
| | 100 |

A 40 kg batch is prepared using the above composition recipe. Processing, including conching, is performed in analogous manner to that for Example 1, and tablet bars are produced.

A second panel of six healthy adult subjects each consume a bar. The IPP is measured during and 30 minutes post-consumption and is greater than 6 and less than 7. There is no IPP below 6.0 during or at 30 minutes following consumption of the chocolate.

### Example 3

Milk chocolate

| | % weight |
|---|---|
| Cocoa butter | 22.5 |
| Cocoa mass | 16.0 |
| Whey protein isolate (Glanbia) | 7.5 |
| Isomaltulose | 50.0 |
| Butter oil | 4.0 |
| Lecithin | <1 |
| Vanillin | <1 |
| Other flavouring | <1 |

A 40 kg batch is prepared using the above composition recipe. After processing including conching, tablet bars are produced.

1. A fat continuous confectionery composition which comprises less than 2% by weight of a fermentable sugar, and a sweetening component in an amount of at least 25% by weight of the composition, wherein the sweetening component comprises at least 50% by weight non-hydrogenated isomaltulose and at least 5% by weight inulin, dextrin or a mixture of inulin and dextrin.

2. A composition as claimed in claim 1 which is free of or substantially free of any polyol component.

3. A composition as claimed in claim 1 wherein the fermentable sugar is present in an amount of less than 1% by weight based on the weight of the composition.

4. A composition as claimed in claim 1 wherein upon consumption results in an IPP of 6.0 or greater.

5. A composition as claimed in claim 1 wherein the sweetening component comprises at least 80% by weight isomaltulose.

6. A composition as claimed in claim 1 wherein the water content is less than 1.75% by weight.

7. A confectionery composition as claimed in claim 1 which is a chocolate composition or a non-chocolate confectionery filling.

8. A confectionery composition as claimed in claim 7 which is a dark chocolate.

9. A fat continuous confectionery composition which comprises: from 1 to 10% by weight of a whey protein isolate that comprises at least 75% by weight protein; less than 2% by weight of a fermentable sugar; and a sweetening component in an amount of at least 25% by weight of the composition, wherein the sweetening component comprises at least 50% by weight non-hydrogenated isomaltulose.

10. A composition as claimed in claim 9 which is free of or substantially free of any polyol component.

11. A composition as claimed in claim 9 wherein the fermentable sugar is present in an amount of less than 1% by weight based on the weight of the composition.

12. A composition as claimed in claim 9 wherein upon consumption results in an IPP of 6.0 or greater.

13. A composition as claimed in claim 9 wherein the sweetening component comprises at least 80% by weight isomaltulose.

14. A composition as claimed in claim 9 wherein the water content is less than 1.75% by weight.

15. A confectionery composition as claimed in claim 9 which is a chocolate composition or a non-chocolate confectionery filling.

16. A confectionery composition as claimed in claim 15 which is a milk chocolate.

17. Use of a composition as claimed in claim 1 for reducing adverse effects on teeth.

18. (canceled)

19. Use of a composition as claimed in claim 1 to maintain an IPP of 6.0 or greater upon consumption by a consumer.

20. Use of a composition as claimed in claim 9 to maintain an IPP of 6.0 or greater upon consumption by a consumer.

21. A composition which comprises, by weight of the composition, about 22% cocoa butter, about 16% cocoa liquor, about 8% milk proteins, about 40% isomaltulose, about 8% inulin, about 6% butter oil, about 1% lecithin and about 1% vanillin.

22. A composition which comprises, by weight of the composition, about 16% cocoa butter, about 32% cocoa liquor, about 40% isomaltulose, about 10% inulin, about 1% Ammonium phosphatides, about 1% PGPR and about 1% vanillin.

23. A composition which comprises, by weight of the composition, about 22% cocoa butter, about 16% cocoa mass, about 50% isomaltulose, about 4% butter oil, about 8% whey protein isolate, about 1% flavoring, about 1% lecithin and about 1% vanillin.
